(19) United States
(12) Patent Application Publication
(10) Pub. No.: US 2019/0212936 A1
(43) Pub. Date: Jul. 11, 2019

(54) MEMORY SYSTEM AND OPERATING METHOD THEREOF

(71) Applicant: SK hynix Inc., Gyeonggi-do (KR)

(72) Inventor: Jong-Min LEE, Seoul (KR)

(21) Appl. No.: 16/058,360

(22) Filed: Aug. 8, 2018

(30) Foreign Application Priority Data
Jan. 5, 2018 (KR) 10-2018-0001816

(51) Int. Cl. G06F 3/06

(52) U.S. Cl. CPC G06F 3/0641; G06F 3/0673; G06F 3/0608

(57) ABSTRACT

An operating method for a memory system includes accumulating any one of a number of accessed word lines or a predetermined access count value, in a nominal access count value for each of the memory block including duplicating accessed word lines; and performing a read reclaim operation onto each of the memory blocks based on the nominal access count value.

### CROSS-REFERENCE TO RELATED APPLICATIONS

The present application claims priority under 35 U.S.C. § 119(a) to Korean Patent Application No. 10-2018-0001816, filed on Jan. 5, 2018, the disclosure of which is incorporated herein by reference in its entirety.

### BACKGROUND

### 1. Field

Various exemplary embodiments of the present invention relate to a memory system including a non-volatile memory device and a controller, and an operating method of the memory system.

### 2. Description of the Related Art

The computer environment paradigm is transitioning into ubiquitous computing, which enables computing systems to be used anytime and anywhere. Consequently, use of portable electronic devices such as mobile phones, digital cameras, and laptop computers has rapidly increased. These portable electronic devices generally use a memory system having one or more memory devices for storing data. The memory system in such devices may be used as a main memory device or an auxiliary memory device.

Memory systems provide excellent stability, durability, high information access speed, and low power consumption since they have no moving parts. Examples of memory systems having such advantages include universal serial bus (USB) memory devices, memory cards having various interfaces, and solid state drives (SSD).

### SUMMARY

Various embodiments of the present invention are directed to a memory system and an operating method of the memory system whose unnecessary read reclaim operation decreases.

In accordance with an embodiment of the present invention, an operating method for a memory system includes accumulating any one of a number of accessed word lines or a predetermined access count, in a nominal access count for each of the memory block including duplicating accessed word lines; and performing a read reclaim operation onto each of the memory block based on the nominal access count.

In accordance with an embodiment of the present invention, a memory system includes: a plurality of memory blocks; and a controller suitable for accumulating any one of a number of accessed word lines or a predetermined access count, in a nominal access count for each of the memory block including duplicating accessed word lines, and performing a read reclaim operation onto each of the memory block based on the nominal access count.

In accordance with an embodiment of the present invention, a memory system, comprising: a memory device including a plurality of memory blocks; and a controller suitable for detecting accesses of the plurality of memory blocks on a word line basis, determining a nominal access value less than a number of accessed word lines for a memory block including duplicating accessed word lines among the plurality of memory blocks, and performing a read reclaim operation on the memory block based on the nominal access value.

### BRIEF DESCRIPTION OF THE DRAWINGS

FIG. 1 is a block diagram illustrating a data processing system in accordance with an embodiment of the present invention.

FIG. 2 is a schematic diagram illustrating an exemplary configuration of a memory device employed in a memory system of FIG. 1.

FIG. 3 is a circuit diagram illustrating an exemplary configuration of a memory cell array of a memory block in a memory device shown in FIG. 1.

FIG. 4 is a block diagram illustrating a data processing system in accordance with an embodiment of the present invention.

FIG. 5 is a flowchart illustrating an operation of a memory system based on a conventional read command.

FIG. 6 is a flowchart illustrating an operation of a memory system based on a read command in accordance with an embodiment of the present invention.

FIGS. 7A and 7B are diagrams illustrating target word line information in accordance with an embodiment of the present invention.

FIG. 8 is a flowchart illustrating an operation of a memory system based on a read command in accordance with an embodiment of the present invention.

FIGS. 9 to 17 are diagrams schematically illustrating application examples of the data processing system, in accordance with various embodiments of the present invention.

### DETAILED DESCRIPTION

Various embodiments of the present invention are described below in more detail with reference to the accompanying drawings. We note, however, that the present invention may be embodied in different other embodiments, forms and variations thereof and should not be construed as being limited to the embodiments set forth herein. Rather, the described embodiments are provided so that this disclosure will be thorough and complete, and will fully convey the present invention to those skilled in the art to which this invention pertains. Throughout the disclosure, like reference numerals refer to like parts throughout the various figures and embodiments of the present invention.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

The drawings are not necessarily to scale and, in some instances, proportions may have been exaggerated in order to clearly illustrate features of the embodiments. When an element is referred to as being connected or coupled to another element, it should be understood that the former can be directly connected or coupled to the latter, or electrically connected or coupled to the latter via an intervening element therebetween.

It will be further understood that when an element is referred to as being “connected to”, or “coupled to” another element, it may be directly on, connected to, or coupled to the other element, or one or more intervening elements may be present. In addition, it will also be understood that when an element is referred to as being between two elements, it may be the only element between the two elements, or one or more intervening elements may also be present.

The terminology used herein is for the purpose of describing particular embodiments only and is not intended to be limiting of the present invention.

As used herein, singular forms are intended to include the plural forms as well, unless the context clearly indicates otherwise.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

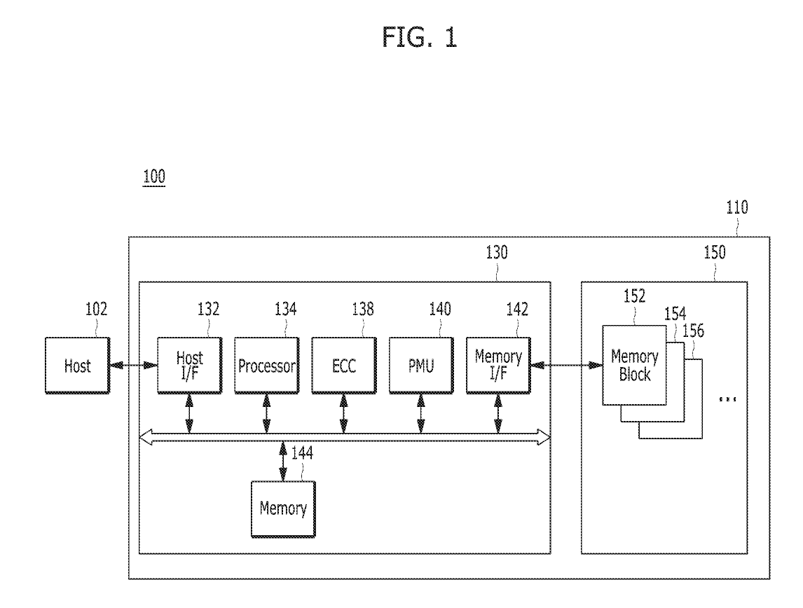

FIG. 1 is a block diagram illustrating a data processing system 100 in accordance with an embodiment of the present invention.

Referring to FIG. 1, the data processing system 100 may include a host 102 operatively coupled to a memory system 110.

The host 102 may include portable electronic devices such as a mobile phone, MP3 player, and laptop computer or non-portable electronic devices such as a desktop computer, game machine, television (TV) and projector.

The host 102 may include at least one operating system (OS). The OS may manage and control overall functions and operations of the host 102, and provide an interface between the host 102 and a user of the data processing system 100 or the memory system 110. The OS may support functions and operations corresponding to the purpose and usage of a user. For example, the OS may be divided into a general OS and a mobile OS, depending on the mobility of the host 102. The general OS may be divided into a personal OS and an enterprise OS, depending on the environment of a user. For example, the personal OS configured to support a function of providing a service to general users may include Windows and Chrome, and the enterprise OS configured to secure and support high performance may include Windows server, Linux and Unix. Furthermore, the mobile OS configured to support a function of providing a mobile service to users and a system power saving function may include Android, iOS and Windows Mobile. The host 102 may include a plurality of OSs, and execute an OS to perform an operation corresponding to a user's request on the memory system 110.

The memory system 110 may store data for the host 102 in response to a request of the host 102. Examples of the memory system 110 may include, but are not limited to, a solid state drive (SSD), multi-media card (MMC), secure digital (SD) card, universal storage bus (USB) device, universal flash storage (UFS) device, compact flash (CF) card, smart media card (SMC), personal computer memory card international association (PCMCIA) card, and memory stick. The MMC may include an embedded MMC (eMMC), reduced size MMC (RS-MMC), and micro-MMC. The SD card may include a mini-SD card and micro-SD card.

The memory system 110 may be embodied by various types of storage devices. Non-limiting examples of storage devices included in the memory system 110 may include volatile memory devices such as a dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM or ReRAM) and a flash memory. The flash memory may have a 3-dimensional (3D) stack structure.

The memory system 110 may include a controller 130 and a memory device 150. The memory device 150 may store data for the host 102, and the controller 130 may control data storage into the memory device 150.

The controller 130 and the memory device 150 may be integrated into a single semiconductor device, which may be included in the various types of memory systems as exemplified above. For example, the controller 130 and the memory device 150 may be integrated as a single semiconductor device to constitute an SSD. When the memory system 110 is used as an SSD, the operating speed of the host 102 connected to the memory system 110 can be improved. In addition, the controller 130 and the memory device 150 may be integrated as a single semiconductor device to constitute a memory card. For example, the controller 130 and the memory device 150 may constitute a memory card such as a personal computer memory card international association (PCMCIA) card, CF card, smart media card (SMC), memory stick, MMC including RS-MMC and micro-MMC, SD card including mini-SD, micro-SD and SDHC, or UFS device.

Non-limiting application examples of the memory system 110 may include a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, or one of various components constituting a computing system.

The memory device 150 may be a nonvolatile memory device and may retain data stored therein even though power is not supplied. The memory device 150 may store data provided from the host 102 through a write operation, and provide data stored therein to the host 102 through a read operation. The memory device 150 may include a plurality of memory blocks 152 to 156, each of the memory blocks may include a plurality of pages, and each of the pages may include a plurality of memory cells coupled to a word line. In an embodiment, the memory device 150 may be a flash memory. The flash memory may have a 3-dimensional (3D) stack structure.

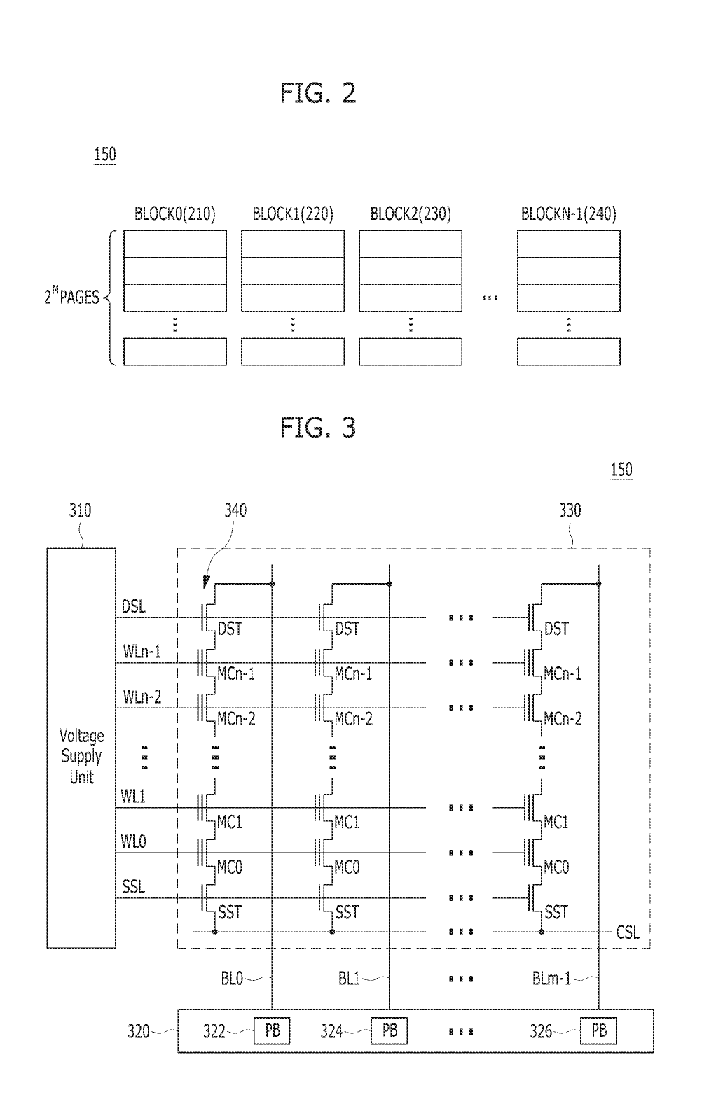

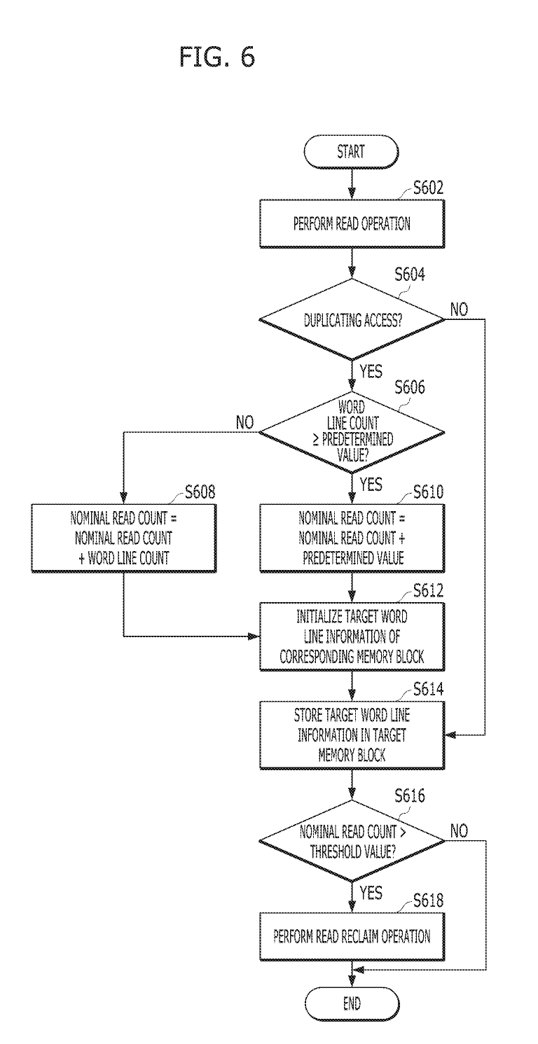

The structure of the memory device 150 and the 3D stack structure of the memory device 150 will be described in detail later with reference to FIGS. 2 to 4. The memory device 150 including a plurality of memory dies, each of which includes a plurality of planes, each of which includes a plurality of memory blocks 152 to 156 will be described in detail later with reference to FIG. 6. Thus, further description of such details is omitted immediately below.

The controller 130 may control the memory device 150 in response to a request from the host 102. For example, the controller 130 may provide data read from the memory device 150 to the host 102, and store data provided from the host 102 into the memory device 150. Thus, the controller 130 may control read, write, program and erase operations of the memory device 150.

The controller 130 may include a host interface (I/F) 132, a processor 134, an error correction code (ECC) 138, a power management unit (PMU) 140, a memory interface (I/F) 142 such as a NAND flash controller (NFC), and a memory 144 all operatively coupled via an internal bus.

The host interface 132 may be configured to process a command and data of the host 102, and may communicate with the host 102 through one or more of various interface protocols such as universal serial bus (USB), multi-media card (MMC), peripheral component interconnect-express (PCI-e or PCIe), small computer system interface (SCSI), serial-attached SCSI (SAS), serial advanced technology attachment (SATA), parallel advanced technology attachment (DATA), enhanced small disk interface (ESDI) and integrated drive electronics (IDE).

The ECC 138 may detect and correct an error contained in the data read from the memory device 150. In other words, the ECC 138 may perform an error correction decoding process on the data read from the memory device 150 through an ECC code used during an ECC encoding process. According to a result of the error correction decoding process, the ECC 138 may output a signal, for example, an error correction success/fail signal. When the number of error bits is greater than a threshold value of correctable error bits, the ECC 138 may not correct the error bits, and may output an error correction fail signal.

The ECC 138 may perform error correction through a coded modulation such as Low Density Parity Check (LDDC) code, Bose-Chaudhri-Hocquenghem (BCH) code, turbo code, Reed-Solomon code, convolution code, Recursive Systematic Code (RSC), Trellis-Coded Modulation (TCM) and Block coded modulation (BCM). However, embodiments of the present invention are not limited to such error correction techniques. Rather, the ECC 138 may perform any suitable error correction technique. The ECC 138 may include all circuits, modules, systems or devices for error correction.

The PMU 140 may provide and manage power of the controller 130.

The memory interface 142 may serve as a memory or storage interface for interfacing the controller 130 and the memory device 150 such that the controller 130 controls the memory device 150 in response to a request from the host 102. When the memory device 150 is a flash memory or specifically a NAND flash memory, the memory interface 142 may generate a control signal for the memory device 150 and process data to be provided to the memory device 150 under the control of the processor 134. The memory interface 142 may work as an interface (e.g., a NAND flash interface) for processing a command and data between the controller 130 and the memory device 150. Specifically, the memory interface 142 may support data transfer between the controller 130 and the memory device 150.

The memory 144 may serve as a working memory of the memory system 110 and the controller 130, and store data for driving the memory system 110 and the controller 130. The controller 130 may control the memory device 150 to perform read, write, program, and erase operations in response to a request from the host 102. The controller 130 may provide data read from the memory device 150 to the host 102, may store data provided from the host 102 into the memory device 150. The memory 144 may store data required for the controller 130 and the memory device 150 to perform these operations.

The memory 144 may be embodied by a volatile memory. For example, the memory 144 may be embodied by a static random access memory (SRAM) or dynamic random access memory (DRAM). The memory 144 may be disposed within the controller 130 or external to the controller 130. FIG. 1 shows an example of the memory 144 disposed within the controller 130. In an embodiment, the memory 144 may be embodied by an external volatile memory having a memory interface transferring data between the memory 144 and the controller 130.

The processor 134 may control the overall operations of the memory system 110. The processor 134 may drive firmware to control the overall operations of the memory system 110. The firmware may be referred to as flash translation layer (FTL). Also, the processor 134 may be realized as a microprocessor or a central processing unit (CPU).

For example, the controller 130 may perform an operation requested by the host 102 in the memory device 150 through the processor 134, which is realized as a microprocessor or a CPU. In other words, the controller 130 may perform a command operation corresponding to a command received from the host 102. For example, the controller 130 may perform a foreground operation as the command operation corresponding to the command received from the host 102. To give more examples, the controller 130 may perform a program operation corresponding to a write command, a read operation corresponding to a read command, an erase operation corresponding to an erase command, and a parameter set operation corresponding to a set parameter command or a set feature command.

Also, the controller 130 may perform a background operation on the memory device 150 through the processor 134, which is realized as a microprocessor or a CPU. Examples of the background operation may include an operation of copying and processing data stored in some of memory blocks 152 to 156 into other such memory blocks, e.g., a garbage collection (GC) operation. Examples of the background operation may include an operation of performing swapping between the memory blocks 152 to 156 or between the data of the memory blocks 152 to 156, e.g., a wear-leveling (WL) operation. Examples of the background operation may include an operation of storing the map data stored in the controller 130 in the memory blocks 152 to 156, e.g., a map flush operation. Examples of the background operation may include an operation of managing bad blocks of the memory device 150, e.g., a bad block management operation of detecting and processing bad blocks among the memory blocks 152 to 156.

Further, the controller 130 may perform a plurality of command operations corresponding to a plurality of commands received from the host 102, e.g., a plurality of program operations corresponding to a plurality of write commands, a plurality of read operations corresponding to a plurality of read commands, and a plurality of erase operations corresponding to a plurality of erase commands. Also, the controller 130 may update meta-data (particularly, map data), according to the command executions.

In the memory system, as the controller 130 continues to perform command operations corresponding to commands received from the host 102, e.g., program operations, read operations, and erase operations, in the memory blocks, such operations may deteriorate the reliability of the memory device 150, which in turn may decrease the utility efficiency of the memory device 150. Therefore, a copy operation or a swap operation may be performed in the memory device 150 in consideration of the parameters for the memory device 150 based on the performance of the command operations.

In various embodiments, when the controller 130 performs program operations corresponding to a plurality of write commands received from the host 102 in the memory blocks, the controller 130 may perform a copy operation, e.g., a garbage collection operation, on the memory device 150 in order to improve the utility efficiency of the memory device 150.

In various embodiments, each of the memory blocks in the memory device 150 may have a limited erase count. Thus, when the controller 130 performs erase operations on the memory blocks corresponding to a plurality of erase commands received from the host 102, the controller 130 may perform such erase operations within range of the limited erase count. For example, when the controller 130 performs erase operations on particular memory blocks exceeding the limited erase count, the particular memory blocks may be processed as bad blocks, which may not be used any more. The limited erase count for the memory blocks of the memory device 150 may represent the maximum number of erase operations that may be performed on the memory blocks. Therefore, erase operations may be performed uniformly within the range of the limited erase count for the memory blocks of the memory device 150. Also, in order to maintain operational reliability of the memory blocks of the memory device 150 as a result of the erase operations, data may be processed with the memory blocks of the memory device 150 in consideration of the parameters of the memory blocks of the memory device 150, for example, a swap operation, e.g., a wear-leveling operation, may be performed in the memory device 150.

In various embodiments, when the controller 130 performs read operations corresponding to a plurality of read commands received from the host 102 in the memory blocks, read disturbance may be caused in the particular memory blocks. Particularly, when the controller 130 repeatedly performs read operations in some particular memory blocks, read disturbance may be caused in the particular memory blocks due to the repeated read operations. Therefore, the controller 130 may perform a read reclaim operation to protect the particular memory blocks from losing data due to the read disturbance. That is, the controller 130 may copy and store the data in the particular memory blocks into other memory blocks through the read reclaim operation. In short, the controller 130 may perform a copy operation for the particular memory blocks in the memory device 150.

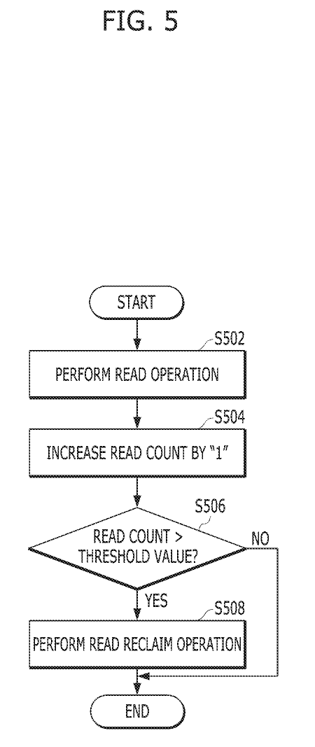

In various embodiments, the controller 130 may perform not only a swap operation and a copy operation but also a bad block management operation for some memory blocks in consideration of the parameters according to the performance of command operations. Non-limiting examples of the parameters according to the performance of command operations may include valid page counts (VPC) of the memory blocks according to the performance of program operations, erase counts according to the performance of erase operations, program counts according to the performance of program operations, and read counts according to the performance of read operations. In various embodiments, the controller 130 may perform a copy operation, e.g., a garbage collection operation, on the memory blocks in consideration of the parameters corresponding to not only the swap operation and the copy operation but also the bad block management operation that are performed in the memory blocks. The performance of the command operations and the performance of the swap operation and the copy operation performed in the memory device 150 in consideration of the parameters corresponding to the performance of such operations will be described in detail later with reference to FIGS. 5 to 9.

The processor 134 of the controller 130 may include a management unit (not illustrated) for performing a bad management operation of the memory device 150. The management unit may perform a bad block management operation of checking a bad memory block, in which a program fail occurs due to a characteristic of the memory device, for example, a NAND flash memory during a program operation. The management unit may write the program-failed data of the bad block to a new memory block. In a memory device 150 having a 3D stack structure, the bad block management operation may reduce the use efficiency of the memory device 150 and the reliability of the memory system 110. Thus, the bad block management operation should be performed with more reliability.

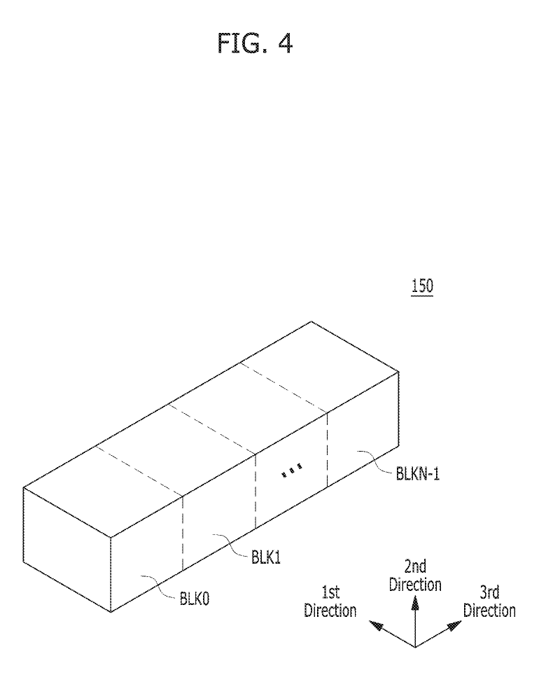

FIG. 2 is a schematic diagram illustrating an exemplary configuration of the memory device 150, FIG. 3 is a circuit diagram illustrating an exemplary configuration of a memory cell array of a memory block 330 in the memory device 150, and FIG. 4 is a schematic diagram illustrating an exemplary 3D structure of the memory device 150.

Referring to FIG. 2, the memory device 150 may include a plurality of memory blocks, e.g., a memory block 0 BLK0 210, a memory block 1 BLK1 220, a memory block 2 BLK2 230, and a memory block N-1 BLKN-1 240. Each of the memory blocks BLK0 210 to BLKN-1 240 may include a plurality of pages, for example, 2^{M} pages, the number of which may vary according to circuit design. Each of the memory blocks 210 to 240 may include 2^{M} pages. However, each of the memory blocks 210 to 240 may include a different number of pages, e.g., M pages. Each of the pages may include a plurality of memory cells that are coupled to a plurality of word lines WL.

Each of the memory blocks may include a single level cell (SLC) memory block storing 1-bit data or a multi-level cell (MLC) memory block storing 2-bit data. The SLC memory blocks may include a plurality of pages that are realized by memory cells storing one-bit data in one memory cell. The SLC memory blocks may have a quick data operation and high durability. The MLC memory blocks may include a plurality of pages that are realized by memory cells storing multi-bit data, e.g., data of two or more bits, in one memory cell. The MLC memory blocks may have a greater data storing space than the SLC memory blocks. That is, the MLC memory blocks may be highly integrated. In an embodiment, the memory device 150 may include the MLC memory blocks each of which includes a plurality of pages that are realized by memory cells capable of storing two-bit data in one memory cell. In an embodiment, the memory device 150 may include triple level cell (TLC) memory blocks each of which includes a plurality of pages that are realized by memory cells capable of storing three-bit data in one memory cell. In an embodiment, the memory device 150 may include quadruple level cell (QLC) memory blocks each of which includes a plurality of pages that are realized by memory cells capable of storing four-bit data in one memory cell. In an embodiment, the memory device 150 may include multiple level cell memory blocks each of which includes a plurality of pages that are realized by memory cells capable of storing five or more-bit data in one memory cell, and the like.

For convenience, the memory device 150 is described in various embodiments as a non-volatile memory, such as a flash memory, e.g., a NAND flash memory. However, the invention is not so limited. Rather, the memory device 150 may be realized in other configurations, such as a phase change random access memory (PCRAM), a resistive random access memory (RRAM or ReRAM), a ferroelectric random access memory (FRAM), a spin transfer torque magnetic random access memory (STT-RAM or STT-MRAM).

The memory blocks BLK0 to BLKN-1 may store the data transferred from the host 102 through a program operation, and transfer data stored therein to the host 102 through a read operation.

Referring to FIG. 3, the memory block 330 may correspond to any of the plurality of memory blocks 152 to 156 included in the memory device 150 of the memory system 110. The memory block 330 may include a plurality of cell strings 340 coupled to a plurality of corresponding bit lines BL0 to BLm-1. The cell string 340 of each column may include one or more drain select transistors DST and one or more source select transistors SST. Between the source and drain select transistors SST and DST, a plurality of memory cells MC0 to MCn-1 may be coupled in series. In an embodiment, each of the memory cell transistors MC0 to MCn-1 may be embodied by an MLC capable of storing data of a plurality of bits. Each of the cell strings 340 may be electrically coupled to a corresponding bit line among the plurality of bit lines BL0 to BLm-1. For example, as illustrated in FIG. 3, the first cell string is coupled to the first bit line BL0, and the last cell string is coupled to the last bit line BLm-1.

Although FIG. 3 illustrates NAND flash memory cells, the invention is not limited in this way. It is noted that the memory cells may be NOR flash memory cells, or hybrid flash memory cells including two or more types of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply unit 310 which provides word line voltages including a program voltage, a read voltage, and a pass voltage to supply to the word lines according to an operation mode. The voltage generation operation of the voltage supply unit 310 may be controlled by a control circuit (not illustrated). Under the control of the control circuit, the voltage supply unit 310 may select one of the memory blocks (or sectors) of the memory cell array, select one of the word lines of the selected memory block, and provide the word line voltages to the selected word line and the unselected word lines.

The memory device 150 may include a read and write (read/write) circuit 320 which is controlled by the control circuit. During a verification/normal read operation, the read/write circuit 320 may operate as a sense amplifier for reading data from a certain memory cell array of the memory block 330. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers (PBs) 322 to 326 respectively corresponding to columns (or bit lines) or column pairs (or bit line pairs). Each of the page buffers 322 to 326 may include a plurality of latches (not illustrated).

The memory device 150 may be embodied by a two-dimensional (2D) or three-dimensional (3D) memory device. Particularly, as illustrated in FIG. 4, the memory device 150 may be embodied by a nonvolatile memory device having a 3D stack structure. When the memory device 150 has a 3D structure, the memory device 150 may include a plurality of memory blocks BLK0 to BLKN-1. FIG. 4 is a block diagram illustrating a plurality of memory blocks BLK0 to BLKN-1 corresponding to the memory blocks 152 to 156 of the memory device 150 shown in FIG. 1. Each of the memory blocks 152 to 156 may be realized in a 3D structure (or vertical structure). For example, the memory blocks 152 to 156 may be 3D structures with dimensions that extend in first to third directions, e.g., an x-axis direction, a y-axis direction, and a z-axis direction.

Each memory block in the memory device 150 may include a plurality of NAND strings NS that extend in each of the first, second and third directions. Each of the NAND strings NS may be coupled to a bit line BL, at least one source selection line SSL, at least one drain selection line DSL, a plurality of word lines WL, at least one dummy word line DWL, and a common source line CSL. Each of the NAND strings NS may include a plurality of transistor structures TS.

In short, each memory block among the memory blocks 152 to 156 of the memory device 150 may be coupled to a plurality of bit lines BL, a plurality of source selection lines SSL, a plurality of drain selection lines DSL, a plurality of word lines WL, a plurality of dummy word lines DWL, and a plurality of common source lines CSL, and each memory block may include a plurality of NAND strings NS. Also, in each memory block, one bit line BL may be coupled to a plurality of NAND strings NS to realize a plurality of transistors in one NAND string NS. Also, a string selection transistor SST of each NAND string NS may be coupled to a corresponding bit line BL, and a ground selection transistor GST of each NAND string NS may be coupled to a common source line CSL. Memory cells MC may be provided between the string selection transistor SST and the ground selection transistor GST of each NAND string NS. In other words, a plurality of memory cells may be realized in each memory block of the memory blocks 152 to 156 of the memory device 150.

An exemplary data processing operation in accordance with an embodiment of the present invention is described in detail with reference to FIGS. 5 to 8.

FIG. 5 is a flowchart illustrating a read operation of a memory system, for example, the memory system 110 of FIG. 1 based on a conventional read command.

At step S502, the controller 130 may control the memory device 150 to perform a read operation on a memory block in response to a read command received from the host 102.

At step S504, the controller 130 may increase a read count value of the memory block on which the read operation is performed by “1”.

At step S506, the controller 130 may check whether or not the read count value exceeds a predetermined threshold value. When the read count value exceeds the predetermined threshold value (that is, “YES” at step S506), the controller 130 may perform the read reclaim operation at step S508. When the read count value does not exceed the predetermined threshold value (that is, “NO” at step S506), the controller 130 may not perform the read reclaim operation and may complete the read operation.

Meanwhile, the disturbance phenomenon occurs mainly in a memory cell coupled to a neighboring word line next to a word line on which the read operation is performed. Accordingly, when the read operation, such as a sequential read operation, is performed evenly on memory cells of a plurality of word lines, the disturbance phenomenon may be distributed over each of the memory cells, whereby probability of read failure due to the disturbance phenomenon may decrease.

When the read operation is performed evenly on the memory cells of the plurality of word lines, even though the read count value for the memory block reaches the predetermined threshold value, the disturbance phenomenon may not be so severe as to perform the read reclaim operation on the memory cells of each word line. Nevertheless, when the read reclaim operation is performed only because the read count value reaches the predetermined threshold value, performance of the memory system 110 may deteriorate as an unnecessary read reclaim operation is frequently performed.

According to an embodiment of the present invention, access to the memory block is detected, for example, on a word line basis. When the access is uniformly performed to a plurality of word lines, a predetermined access count value less than an actual access count value may be determined as a nominal access count value of the memory block. Therefore, the unnecessary read reclaim operation may be reduced and the performance of the memory system 100 may be improved.

FIG. 6 is a flowchart illustrating a read operation of a memory system, for example, the memory system 110 of FIG. 1, based on a read command in accordance with an embodiment of the present invention.

In step 602, the controller 130 may control the memory device 150 to perform a read operation on a target memory block in response to a read command received from the host 102. Specifically, the controller 130 may provide the memory device 150 with target word line information. In various embodiments, the target word line information may include a physical address of a start target word line on which the read operation starts to be performed in the target memory block and the number of target word lines to be read from the start target word line, as shown as target word line information 146 in

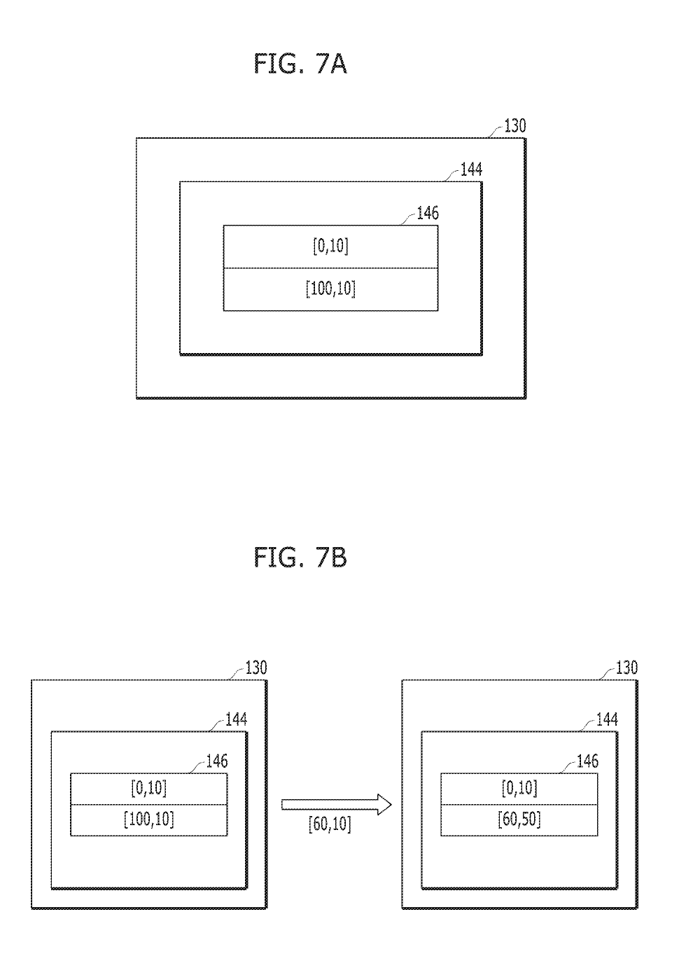

FIGS. 7A and 7B. The target word line information 146 may be stored in the memory 144.

FIGS. 7A and 7B are diagrams illustrating the target word line information 146 in accordance with an embodiment of the present invention.

One or more target word line information 146 for one or more memory blocks may be stored in the memory 144.

Referring to FIG. 7A, the memory 144 may store two target word line information 146 for one target memory block. Specifically, first target word line information and second target word line information may be stored in the memory 144. The first target word line information may include a physical address of a start target word line related to a first read operation having a value “0”, and the number of target word lines having a value of “10”. The second target word line information may include a physical address of a start target word line related to a second read operation a value “100”, and the number of target word lines having a value “10”.

The controller 130 may control the memory device 150 to perform the first read operation on word lines WL0 to WL9 of the target memory block in response to the read command received from the host 102, and store the first target word line information [0, 10] in the memory 144. Similarly, when the second read operation is performed on word lines WL100 to WL109 of the target memory block in response to the read command of the host 102, the controller 130 may store the second target word line information [100, 10] in the memory 144.

According to another embodiment, when a capacity of the memory 144 is not enough to store the target word line information for all the memory blocks, a plurality of target word line information may be merged.

Referring to FIG. 7B, when the read operation is performed on word lines WL60 to WL69 of a specific memory block and thus, third target word line information [60, 10] is stored in the memory 144 while the first and second target word line information [0, 10] and [100, 10] of the memory block are stored in the memory 144, the controller 130 may store fourth target word line information [0, 70] instead of the first and third target word line information [0, 10] and [60, 10] in the memory 144 by merging the first target word line information [0, 10] and the third target word line information [60, 10]. Alternatively, the controller 130 may store fifth target word line information [60, 50] instead of the second and third target word line information [100, 10] and [60, 10] in the memory 144 by merging the second target word line information [100, 10] and the third target word line information [60, 10], FIG. 7B shows the memory 144 in which the first target word line information and the fifth target word line information are stored.

When the plurality of target word line information is merged, the target word line information to be merged may be selected so that the number of target word lines included in target word line information to be newly generated is minimized. As described above, when the second target word line information [100, 10] and the fourth target word line information [0, 70] are stored, the number of the target word lines is 80. When the first target word line information [0, 10] and the fifth target word line information [60, 50] are stored, the number of the target word lines is 60. As the second target word line information [100, 10] and the third target word line information [60, 10] are selected as the target word line information to be merged, the first target word line information [0, 10] and the fifth target word line information [60, 50] may be stored.

As exemplified in FIGS. 7A and 7B, the number of the target word line information 146 may not coincide with the actual number of memory blocks or word lines. When the number of the target word line information 146 is less than the actual number of memory blocks or word lines, a process amount of the processor 134 may decrease, whereby the performance of the memory system 110 may be improved. When the number of the target word line information 146 is greater than the actual number of memory blocks or word lines, whether or not duplicating access is performed on a word line may be accurately determined.

Referring back to FIG. 6, at step S604, the controller 130 may check whether or not the duplicating access occurs in the target memory block. The duplicating access may represent a case where the read operation is performed again on a word line on which the read operation has already been performed on.

At step S604, the controller 130 may determine whether or not the duplicating access is performed on the target memory block by comparing the target word line information 146 previously stored in the memory 144 with current target word line information corresponding to the current read operation, which is performed at step S602.

For example, as exemplified in FIG. 7B, when memory cells coupled to 20 word lines from word line WL0 of a specific memory block are read at step S602 while the target word line information [0, 10] and [60, 50] for the memory block are stored in the memory 144, the target word line information for the memory block, which corresponds to the current read operation, may be [0, 20]. In this case, the controller 130 may determine that the duplicating access is performed on memory cells coupled to the word lines WL0 to WL9 in the memory block by comparing the target word line information [0, 10] and [60, 50] previously stored in the memory 144 with the target word line information [0, 20] generated newly.

When the duplicating access is not performed (that is, “NO” at step S604), at step S614, the controller 130 may store the current target word line information corresponding to the current read operation, which is performed on the target memory block at step S602, in the memory 144.

At step S616, the controller 130 may check whether or not a nominal read count value of the memory block exceeds a predetermined threshold value.

When the nominal read count value exceeds the predetermined threshold value (that is, “YES” at step S616), at step S618, the controller 130 may perform the read reclaim operation. The nominal read count value will be described below.

When the nominal read count value does not exceed the predetermined threshold value (that is, “NO” at step S616), the controller 130 may not perform the read reclaim operation and complete an operation corresponding to the read command.

When the duplicating access is performed (that is, “YES” at step S604), at step S606, the controller 130 may check whether a word line count value is equal to or greater than a predetermined value.

The word line count value may be a sum of the numbers of the target word lines included in all the target word line information, which are stored in the memory 144, for the target memory block.

The predetermined value may be experimentally determined by reflecting a degree of the disturbance phenomenon that may occur when all the word lines of the memory block are evenly accessed.

When the word line count value is equal to or greater than the predetermined value (that is, “YES” at step S606), it may be determined that a large number of the word lines coupled to the target memory block are evenly accessed until the duplicating access is performed. Accordingly, at step S610, the controller 130 may accumulate the predetermined value which is equal to or less than the word line count value in the nominal read count of the memory block.

At step S612, the controller 130 may delete and initialize all the target word line information, which are stored in the memory 144, for the target memory block.

When the word line count value is less than the predetermined value (that is, “NO” at step S606), it may be determined that a small number of the word lines coupled to the target memory block are accessed until the duplicating access is performed. In this case, since the disturbance phenomenon occurs intensively, it may be desirable to accurately reflect an actual read count value. Accordingly, at step S608, the controller 130 may accumulate the word line count value in the nominal read count value of the memory block. Subsequently, the step S612, which is described above, may be carried out.

The steps S614 to S618, which are described above, subsequent to the step S612 may be carried out.

As described above, when the small number of the word lines of the target memory block are intensively accessed, the word line count value representing the number of word lines to be read in actuality may be accumulated as the nominal read count value, and when the read operation is performed evenly on the large number of the word lines, the disturbance phenomenon may be distributed. Hence, the predetermined value which is less than the number of the word lines to be read in actuality may be accumulated as the nominal read count value. Accordingly, the unnecessary read reclaim operation may be reduced, and the performance of the memory system 110 may be improved.

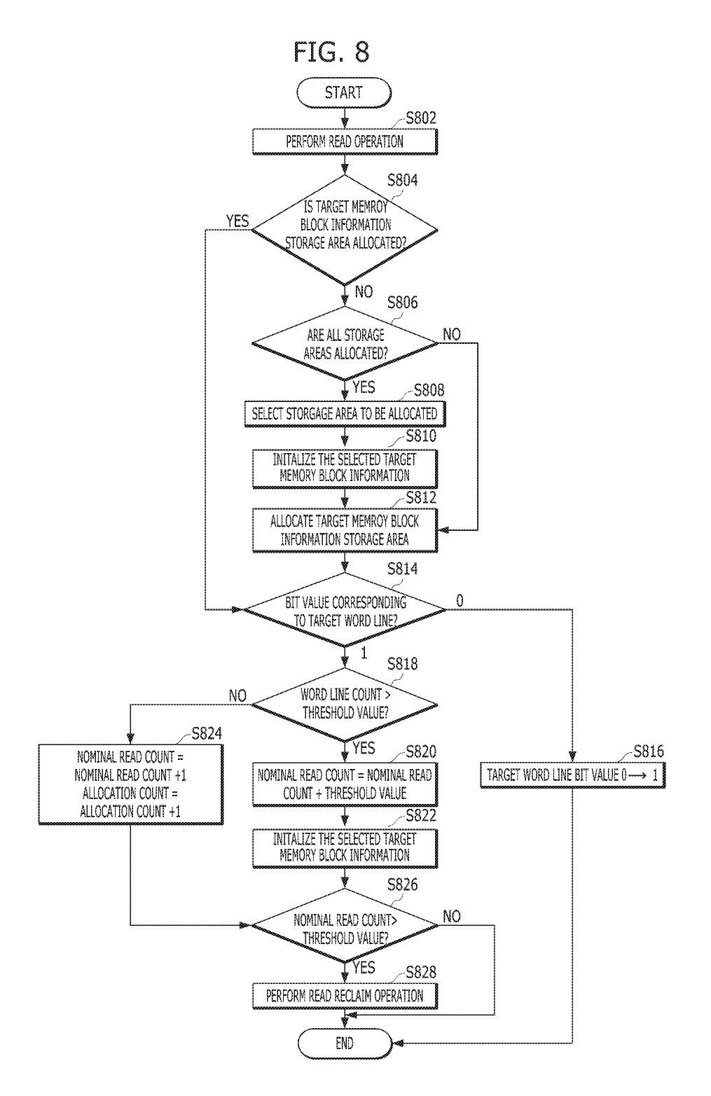

FIG. 8 is a flowchart illustrating a read operation of a memory system, for example, the memory system 110 of FIG. 1, based on a read command in accordance with another embodiment of the present invention.

At step S802, the controller 130 may control the memory device 150 to perform a read operation on a current target memory block in response to a read command received from the host 102. Specifically, the controller 130 may provide the memory device 150 with target word line information including a physical address of a word line to be read.

According to the embodiment of the present invention, target memory block information including whether or not access to the target memory block is performed (hereinafter, referred to as word line access information) may be stored in the memory 144. The target memory block information may include a structure of a bitmap. For example, each bit of the bitmap may represent whether or not access to each word line of the target memory block is performed.

Meanwhile, a capacity of the memory 144 may not be enough to store the target memory block information for all the memory blocks. According to the embodiment of the present invention, the controller 130 may allocate a storage area of the memory 144 so as to preferentially store the target memory block information for a lately accessed memory block.

According to another embodiment of the present invention, the target memory block information may include information regarding at least one of a target memory block address, an allocation count value, allocation time and a correction time other than word line access information.

The allocation count value may determine whether or not to allocate an area in which the target memory block information is stored to an area to store target memory block information of a new target memory block. The allocation time may include a time allocated for storing the target memory block information in the storage area of the memory 144. The correction time may include a time where the target memory block information is corrected as the target memory block is accessed.

At steps S804 to S812, the controller 130 may check whether or not an area to store the target memory block information for the current target memory block is allocated in the memory 144. When the area is not allocated in the memory 144, the controller 130 may initialize the storage area of the memory 144 allocated to store target memory block information of another block according to a predetermined criterion and allocate the target memory block information to the storage area.

Specifically, at step S804, the controller 130 may check whether or not the area to store the target memory block information for the current target memory block is allocated in the memory 144.

When the area to store the target memory block information is allocated in the memory 144 (that is, “YES” at step S804), the controller 130 may proceed to step S814 and perform operations of steps S814 to S828, which are to be described below.

When the area to store the target memory block information is not allocated in the memory 144 (that is, “NO” at step S804), the controller 130 may check whether or not the area to store the target memory block information in the memory 144 is allocated for another memory block at step S806.

When the area to store the target memory block information in the memory 144 is not allocated for another memory block (that is, “NO” at step S806), the controller 130 may allocate the storage area of the memory 144 which is not allocated to the area to store the target memory block information of the current target memory block and perform the operations of steps S814 to S828.

When the area to store the target memory block information in the memory 144 is allocated for another memory block (that is, “YES” at step S806), the controller 130 may determine whether or not to allocate an area in which target memory block information of a memory block is stored to the area in which the target memory block information of the current target memory block is stored in step S808.

A criterion for determining the above may be the information such as allocation count value, the allocation time and the correction time.

The controller 130 may select the target memory block information of which the allocation count value is greater or the target memory block information of which the allocation time or the correction time is longer and firstly allocate the area in which corresponding target memory block information is stored to the area in which the target memory block information of the current target memory block is stored. The allocation count value will be described in detail below.

The controller 130 may initialize the selected target memory block information representing selected storage area at step S810, and may newly allocate an area in which the initialized information is stored to the area in which the target memory block information of the current target memory block is stored, which is shown at step S812. At steps S814 to S828, the controller 130 may store the word line access information in the target memory block information having the structure of the bitmap, for example, for each word line, and thus may accumulate a predetermined value as a nominal read count value and perform the read reclaim operation based on the nominal read count value.

Specifically, at step S814, the controller 130 may check whether or not a target word line is previously accessed, referring to a bit value corresponding to the target word line to be read from the current target memory block information.

According to the embodiment of the present invention, for the current target memory block information, a bit value “0” may represent that a corresponding word line is not previously accessed, and a bit value “1” may represent that the corresponding word line is previously accessed.

When the bit value is “0” (that is, “0” at step S814), the controller 130 may indicate that the word line is accessed, by setting the bit value of the current target memory block information to “1” at step S816.

When the bit value is “1” (that is, “1” at step S814), the controller 130 may check whether a word line count value is equal to or greater than a predetermined value at step S818.

The word line count value may represent the number of word lines accessed in the target memory block. In the present embodiment, the word line count value may be expressed by the number of bits having a bit value “1” in the bitmap of the target memory block information.

When the word line count value is equal to or greater than the predetermined value (that is, “YES” at step S818), it may be determined that access is evenly performed across a plurality of word lines of the memory block until duplicating access occurs. Thus, at step S820, the controller 130 may accumulate the predetermined value less than or equal to the word line count value in the nominal read count of the memory block. At step S822, the controller 130 may initialize the target memory block information representing allocated storage area.

When the word line count value is less than the predetermined value (that is, “NO” at step S818), it may be determined that duplicating access has been performed immediately after a small number of word lines are accessed. At this time, disturbance phenomenon may be concentrated, so it may be desirable to accurately reflect an actual read count value. Accordingly, at step S824, the controller 130 may add “1” to the nominal read count value without initializing the target memory block information, and add “1” to an allocation count value. In other words, the controller 130 may increase the nominal read count value and increase the allocation count value.

The read count value of the current target word line may be reflected when the bit value corresponding to the current target word line is “1” by adding “1” to the nominal read count value. “1” may be added to the allocation count value to indicate that duplicating access is being performed in the current target memory block without the bitmap being initialized.

When the current target memory block information is not initialized and the duplicating access is continuously performed onto the corresponding memory block, the allocation count value may increase. When the storage area of the memory 144 for storing target memory block information of a new memory block is insufficient, the current target memory block information may be initialized, and the storage area of the memory 144 where the current target memory block information is stored may be allocated to store the target memory block information of the new memory block.

When the nominal read count value exceeds a predetermined threshold (that is, “YES” at step S826), the controller 130 may perform the read rewrite operation at step S828, and complete the operation based on the read command. When the nominal read count value does not exceed the predetermined threshold (that is, “NO” at step S826), the controller 130 may complete the operation based on the read command.

According to an embodiment of the present invention, each bit of the bitmap of the target memory block information may set a plurality of word lines instead of an individual word line to word line groups to indicate whether or not each of the word line groups is accessed.

The operation of the memory system according to the present embodiment is described again below with reference to FIG. 8.

Steps S802 to S812 are as described above.

At step S814, the controller 130 may refer to a bit value corresponding to a word line group to which a target word line to be read from the target memory block information belongs, thereby checking whether the word line has been accessed previously.

When the bit value is “0” (that is, “0” at step S814), it may mean that any one of the word lines of the word line group is not accessed. In this case, at step S816, the bit value may be set to “1” to indicate that at least one of the word lines of the word line group is accessed.

When the bit value is “1” (that is, “1” at step S814), the controller 130 may check whether a word line count value is equal to or greater than a predetermined value. In the present embodiment, the word line count value may include a value obtained by multiplying the number of bits whose bit value of the bit map is “1”′ by the number of word lines belonging to the word line group.

When the word line count value is equal to or greater than the predetermined value (that is, “YES” at step S818), the controller 130 may count the predetermined value in the nominal read count value of the target memory block at step S820, and initialize the bitmap at step S822.

When the word line count value is less than the predetermined value (that is, “NO” at step S818), the controller 130 may not initialize the target memory block information. Instead, the controller 130 may add the number of the word line belonging to the word line group to the nominal read count value. At this time, instead of “1”, the controller 130 may add the number of the word line belonging to the word line group to the nominal read count value. Further, the controller 130 may add “1” to the allocation count value.

Steps S826 and S828 are as described above.

When a plurality of word lines is set to a word line group, and each bit of the target memory block information or the word line access information stores whether or not the word line group is accessed, the throughput of the processor 134 may be low, and thus the performance of the memory system 110 may be improved. Conversely, when each bit of the target memory block information or the word line access information stores whether or not an individual word line is accessed, it may be accurately detected whether or not the target word line is accessed.

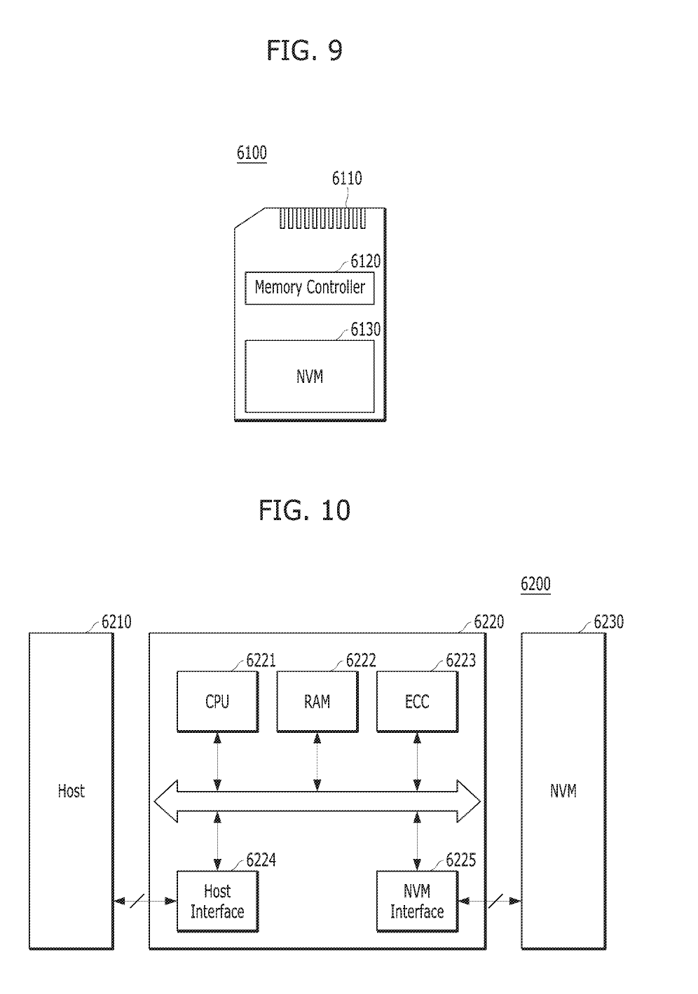

A data processing system and electronic devices to which the memory system 110 including the memory device 150 and the controller 130, which are described above with reference to FIGS. 1 to 8, are described in detail below with reference to FIGS. 9 to 17, in accordance with an embodiment of the present invention.

FIG. 9 is a diagram schematically illustrating an example of the data processing system including the memory system in accordance with the present embodiment. Specifically, FIG. 9 schematically illustrates a memory card system 6100 to which the memory system in accordance with the present embodiment is applied.

Referring to FIG. 9, the memory card system 6100 may include a memory controller 6120, a memory device 6130 and a connector 6110.

More specifically, the memory controller 6120 may be connected to the memory device 6130, embodied by a nonvolatile memory (NVM), and configured to access the memory device 6130. For example, the memory controller 6120 may be configured to control read, write, erase and background operations of the memory device 6130. The memory controller 6120 may be configured to provide an interface between the memory device 6130 and a host (not shown), and drive firmware for controlling the memory device 6130. That is, the memory controller 6120 may correspond to the controller 130 of the memory system 110 described with reference to FIG. 1, and the memory device 6130 may correspond to the memory device 150 of the memory system 110 described with reference to FIG. 1.

Thus, as shown in FIG. 1, the memory controller 6120 may include a random access memory (RAM), a processing unit, a host interface, a memory interface and an error correction unit.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), WIFI and Bluetooth. Thus, the memory system and the data processing system in accordance with the present embodiment may be applied to wired/wireless electronic devices or particularly mobile electronic devices.

The memory device 6130 may be implemented by a nonvolatile memory. For example, the memory device 6130 may be implemented by various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM).

The memory controller 6120 and the memory device 6130 may be integrated into a single semiconductor device. For example, the memory controller 6120 and the memory device 6130 may construct a solid-state driver (SSD) by being integrated into a single semiconductor device. Also, the memory controller 6120 and the memory device 6130 may construct a memory card such as a PC card (e.g., Personal Computer Memory Card International Association (PCMCIA)), a compact flash (CF) card, a smart media card (e.g., SM and SMC), a memory stick, a multimedia card (e.g., MMC, RS-MMC, MMCmicro and eMMC), a secure digital (SD) card (e.g., SD, miniSD, microSD and SDHC) and a universal flash storage (UFS).

FIG. 10 is a diagram schematically illustrating another example of a data processing system 6200 including the memory system in accordance with the present embodiment.

Referring to FIG. 10, the data processing system 6200 may include a memory device 6230 having one or more nonvolatile memories (NVMs) and a memory controller 6220 for controlling the memory device 6230. The data processing system 6200 may serve as a storage medium such as a memory card (e.g., CF, SD, micro-SD or the like) or USB device, as described with reference to FIG. 1. The memory device 6230 may correspond to the memory device 150 in the memory system 110 illustrated in FIG. 1, and the memory controller 6220 may correspond to the controller 130 in the memory system 110 illustrated in FIG. 1.

The memory controller 6220 may control a read, write or erase operation on the memory device 6230 in response to a request of a host 6210, and the memory controller 6220 may include one or more central processing units (CPUs) 6221, a buffer memory such as a random access memory (RAM) 6222, an error correction code (ECC) circuit 6223, a host interface 6224 and a memory interface such as an NVM interface 6225.

The CPU 6221 may control overall operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the memory device 6230 to operate at high speed.

The ECC circuit 6223 may correspond to the ECC 138 of the controller 130 illustrated in FIG. 1. As described with reference to FIG. 1, the ECC circuit 6223 may generate an error correction code (ECC) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. At this time, the ECC circuit 6223 may correct an error using the parity bit. For example, as described with reference to FIG. 1, the ECC circuit 6223 may correct an error using Low Density Parity Check (LDPC) code, Bose-Chaudhri-Hocquenghem (BCH) code, turbo code, Reed-Solomon code, convolution code, Recursive Systematic Code (RSC) or coded modulation such as Trellis-Coded Modulation (TCM) or Block coded modulation (BCM).

The memory controller 6220 may transmit and receive data to and from the host 6210 through the host interface 6224, and transmit and receive data to and from the memory device 6230 through the NUM interface 6225. The host interface 6224 may be connected to the host 6210 through a parallel advanced technology attachment (PATA) bus, serial advanced technology attachment (SATA) bus, small computer system interface (SCSI), universal serial bus (USB), peripheral component interconnect-express (PCIe) or NAND interface. The memory controller 6220 may have a wireless communication function with a mobile communication protocol such as wireless fidelity (WiFi) or Long Term Evolution (LTE). The memory controller 6220 may be connected to an external device, for example, the host 6210 or another external device, and then transmit and receive data to and from the external device. In particular, as the memory controller 6220 is configured to communicate with the external device through one or more of various communication protocols, the memory system and the data processing system in accordance with the present embodiment may be applied to wired and/or wireless electronic devices or particularly a mobile electronic device.

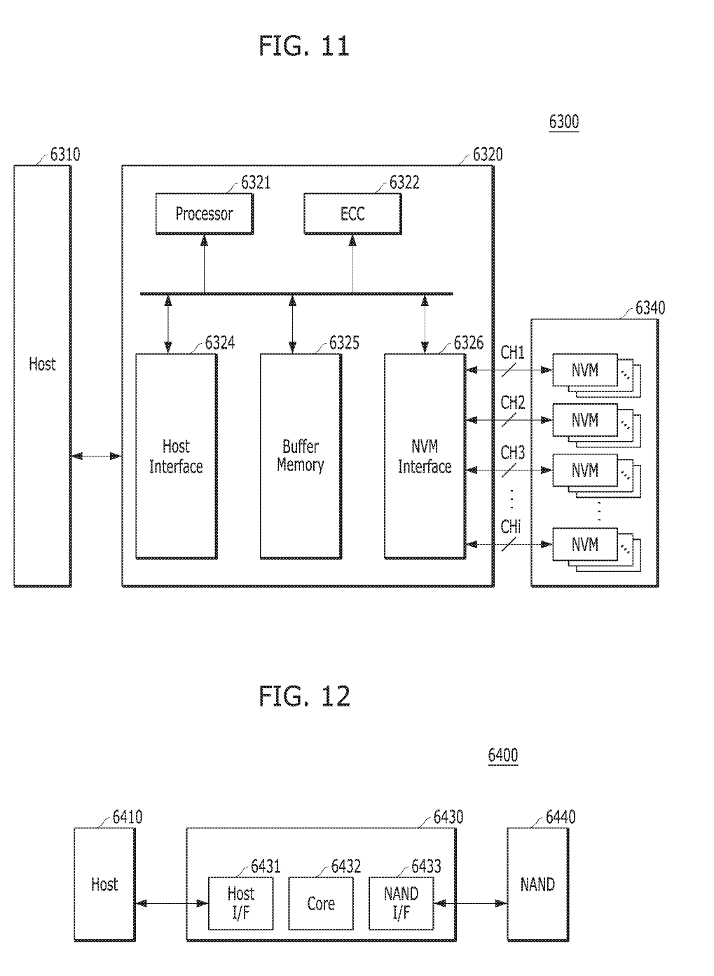

FIG. 11 is a diagram schematically illustrating another example of the data processing system including the memory system in accordance with the present embodiment. Specifically, FIG. 11 schematically illustrates a solid state drive (SSD) 6300 to which the memory system in accordance with the present embodiment is applied.

Referring to FIG. 11, the SSD 6300 may include a controller 6320 and a memory device 6340 including a plurality of nonvolatile memories (NVMs). The controller 6320 may correspond to the controller 130 in the memory system 110 of FIG. 1, and the memory device 6340 may correspond to the memory device 150 in the memory system of FIG. 1

More specifically, the controller 6320 may be connected to the memory device 6340 through a plurality of channels CH1 to CHi. The controller 6320 may include one or more processors 6321, an error correction code (ECC) circuit 6322, a host interface 6324, a buffer memory 6325 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by volatile memories such as a dynamic random access memory (DRAM), a synchronous DRAM (SDRAM), a double data rate (DDR) SDRAM, a low power DDR (LPDDR) SDRAM and a graphics RAM (GRAM) or nonvolatile memories such as a ferroelectric RAM (FRAM), a resistive RAM (RRAM or ReRAM), a spin-transfer torque magnetic RAM (STT-MRAM) and a phase-change RAM (PRAM). For convenience of description, FIG. 8 illustrates that the buffer memory 6325 exists in the controller 6320. However, the buffer memory 6325 may exist external to the controller 6320.

The ECC circuit 6322 may calculate an error correction code (ECC) value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIG. 1 is applied may be provided to embody a data processing system, for example, a Redundant Array of Independent Disks (RAID) system. At this time, the RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 12 is a diagram schematically illustrating another example of the data processing system including the memory system in accordance with the present embodiment. Specifically, FIG. 12 schematically illustrates an embedded Multi-Media Card (eMMC) 6400 to which the memory system in accordance with the present embodiment is applied.

Referring to FIG. 12, the eMMC 6400 may include a controller 6430 and a memory device 6440 embodied by one or more NAND flash memories. The controller 6430 may correspond to the controller 130 in the memory system 110 of FIG. 1, and the memory device 6440 may correspond to the memory device 150 in the memory system 110 of FIG. 1.

More specifically, the controller 6430 may be connected to the memory device 6440 through a plurality of channels. The controller 6430 may include one or more cores 6432, a host interface (I/F) 6431 and a memory interface, for example, a NAND interface (I/F) 6433.

The core 6432 may control overall operations of the eMMC 6400. The host interface 6431 may provide an interface function between the controller 6430 and the host 6410. The NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, Ultra High Speed (UHS)-I and UHS-II interface.

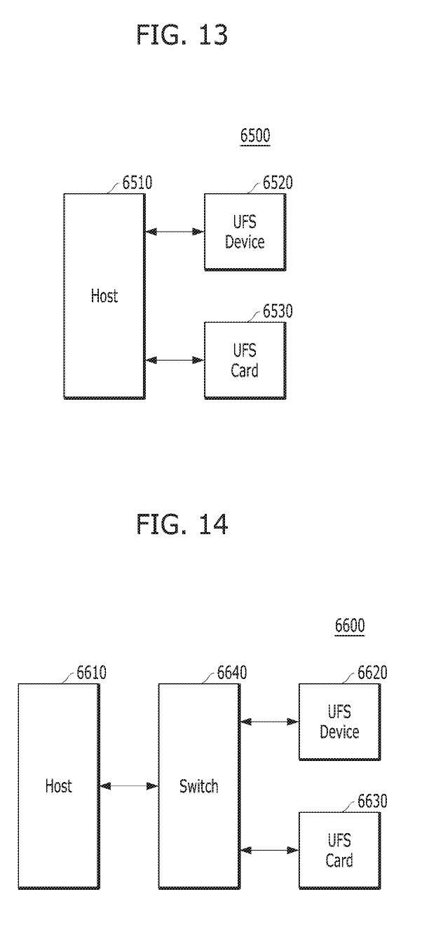

FIGS. 13 to 16 are diagrams schematically illustrating other examples of the data processing system including the memory system in accordance with the present embodiment. Specifically, FIGS. 13 to 16 schematically illustrate universal flash storage (UFS) systems to which the memory system in accordance with the present embodiment is applied.

Referring to FIGS. 13 to 16, the UFS systems 6500, 6600, 6700 and 6800 may include hosts 6510, 6610, 6710 and 6810, UFS devices 6520, 6620, 6720 and 6820 and UFS cards 6530, 6630, 6730 and 6830, respectively. The hosts 6510, 6610, 6710 and 6810 may serve as application processors of wired and/or wireless electronic devices including mobile electronic devices, the UFS devices 6520, 6620, 6720 and 6820 may serve as embedded UFS devices. The UFS cards 6530, 6630, 6730 and 6830 may serve as external embedded UFS devices or removable UFS cards.

The hosts 6510, 6610, 6710 and 6810, the UFS devices 6520, 6620, 6720 and 6820 and the UFS cards 6530, 6630, 6730 and 6830 in the respective UFS systems 6500, 6600, 6700 and 6800 may communicate with external devices, for example, wired and/or wireless electronic devices or particularly mobile electronic devices through UFS protocols. The UFS devices 6520, 6620, 6720 and 6820 and the UFS cards 6530, 6630, 6730 and 6830 may be embodied by the memory system 110 illustrated in FIG. 1. For example, in the UFS systems 6500, 6600, 6700 and 6800, the UFS devices 6520, 6620, 6720 and 6820 may be embodied in the form of the data processing system 6200, the SSD 6300 or the eMMC 6400 described with reference to FIGS. 10 to 12, and the UFS cards 6530, 6630, 6730 and 6830 may be embodied in the form of the memory card system 6100 described with reference to FIG. 9.

Furthermore, in the UFS systems 6500, 6600, 6700 and 6800, the hosts 6510, 6610, 6710 and 6810, the UFS devices 6520, 6620, 6720 and 6820 and the UFS cards 6530, 6630, 6730 and 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720 and 6820 and the UFS cards 6530, 6630, 6730 and 6830 may communicate with each other through various protocols other than the UFS protocol, for example, universal storage bus (USB) Flash Drives (UFDs), a multi-media card (MMC), a secure digital (SD), mini-SD, and micro-SD.

In the UFS system 6500 illustrated in FIG. 13, each of the host 6510, the UFS device 6520 and the UFS card 6530 may include UniPro. The host 6510 may perform a switching operation in order to communicate with the UFS device 6520 and the UFS card 6530. In particular, the host 6510 may communicate with the UFS device 6520 or the UFS card 6530 through link layer switching, for example, L3 switching at the UniPro. The UFS device 6520 and the UFS card 6530 may communicate with each other through link layer switching at the UniPro of the host 6510. In the present embodiment, the configuration in which one UFS device 6520 and one UFS card 6530 are connected to the host 6510 is described by way of example. However, a plurality of UFS devices and UFS cards may be connected in parallel or in the form of a star to the host 6510, and a plurality of UFS cards may be connected in parallel or in the form of a star to the UFS device 6520 or connected in series or in the form of a chain to the UFS device 6520.

In the UFS system 6600 illustrated in FIG. 14, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In the present embodiment, the configuration in which one UFS device 6620 and one UFS card 6630 are connected to the switching module 6640 is described by way of example. However, a plurality of UFS devices and UFS cards may be connected in parallel or in the form of a star to the switching module 6640, and a plurality of UFS cards may be connected in series or in the form of a chain to the UFS device 6620.

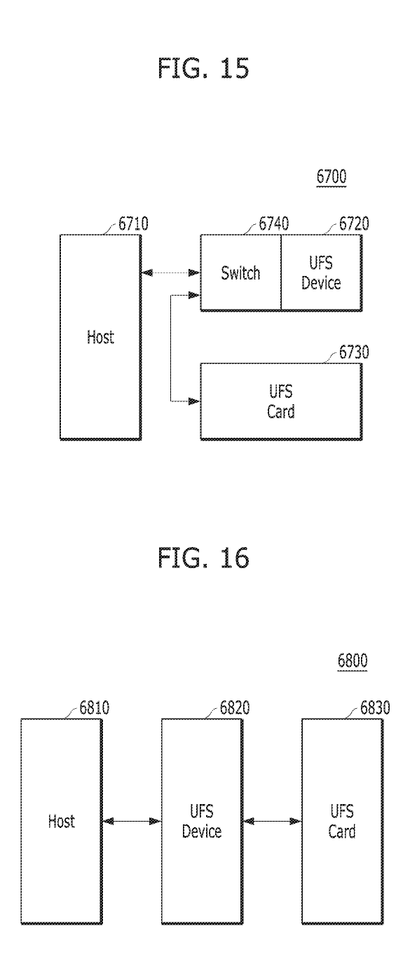

In the UFS system 6700 illustrated in FIG. 15, each of the host 6710, the UFS device 6720 and the UFS card 6730 may include UniPro. The host 6710 may communicate with the UFS device 6720 or the UFS card 6730 through a switching module 6740 performing a switching operation, for example, through the switching module 6740 which performs link layer switching at the UniPro, for example, L3 switching. The UFS device 6720 and the UFS card 6730 may communicate with each other through link layer switching of the switching module 6740 at the UniPro, and the switching module 6740 may be integrated as one module with the UFS device 6720 inside or outside the UFS device 6720. In the present embodiment, the configuration in which one UFS device 6720 and one UFS card 6730 are connected to the switching module 6740 is described by way of example. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 16, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target Identifier (ID) switching operation. The host 6810 and the UFS card 6830 may communicate with each other through target ID switching between the M-PHY and UniPro modules of the UFS device 6820. In the present embodiment, the configuration in which one UFS device 6820 is connected to the host 6810 and one UFS card 6830 is connected to the UFS device 6820 is described by way of example. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

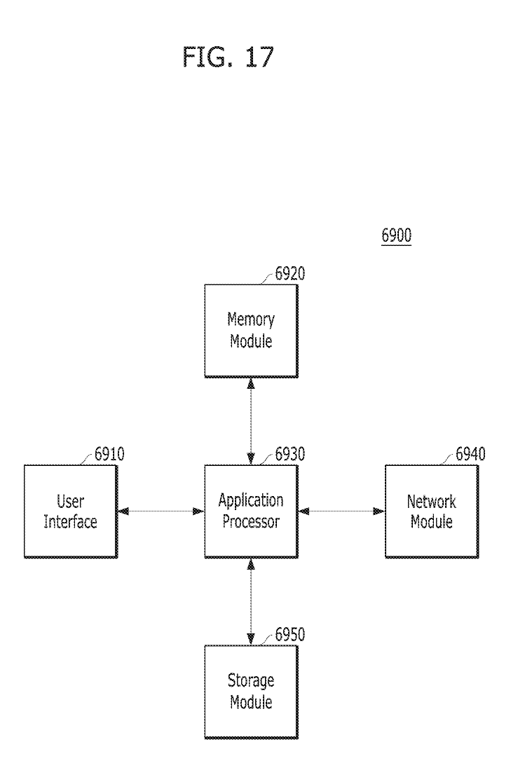

FIG. 17 is a diagram schematically illustrating another example of the data processing system including the memory system in accordance with an embodiment of the present invention, and more particularly illustrating a user system 6900 to which the memory system in accordance with the present embodiment is applied.

Referring to FIG. 17, the user system 6900 may include a user interface 6910, a memory module 6920, an application processor 6930, a network module 6940, and a storage module 6950.

More specifically, the application processor 6930 may drive components included in the user system 6900, for example, an operating system (OS), and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile random access memory (RAM) such as a dynamic RAM (DRAM), a synchronous DRAM (SDRAM), a double data rate (DDR) SDRAM, DDR2 SDRAM, DDR3 SDRAM, a low power DDR (LPDDR) SDARM, LPDDR3 SDRAM or LPDDR3 SDRAM or a nonvolatile RAM such as a phase-change RAM (PRAM), a resistive RAM (ReRAM), a magneto-resistive RAM (MRAM) or a ferroelectric RAM (FRAM). For example, the application processor 6930 and the memory module 6920 may be packaged and mounted, based on Package on Package (PoP).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices including mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, eMMC and UFS as described above with reference to FIGS. 11 to 16.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a monitor.

Furthermore, when the memory system 110 of FIG. 1 is applied to a mobile electronic device of the user system 6900, the application processor 6930 may control overall operations of the mobile electronic device, and the network module 6940 may serve as a communication module for controlling wired and/or wireless communication with an external device. The user interface 6910 may display data processed by the processor 6930 on a display and touch module of the mobile electronic device, or support a function of receiving data from the touch panel.

While the present invention has been described with respect to specific embodiments, it will be apparent to those skilled in the art that various changes and modifications may be made without departing from the spirit and scope of the invention as defined in the following claims.

What is claimed is:

1. An operating method for a memory system,comprising:
accumulating any one of a number of accessed word lines or a predetermined access count value, in a nominal access count value for each of the memory block including duplicating accessed word lines; and
performing a read reclaim operation onto each of the memory blocks based on the nominal access count value.

2. The operating method of claim 1, further comprising:
storing a plurality pieces of memory block information including the number of the accessed word lines.

3. The operating method of claim 2, further comprising:
initializing the memory block information.

4. The operating method of claim 2, wherein the memory block information further includes a physical address of a word line to be accessed.

5. The operating method of claim 2, wherein the plurality pieces of memory block information include one or more pieces of memory block information for each of the memory blocks.

6. The operating method of claim 1, further comprising:
storing a plurality pieces of memory block information including information regarding the accessed word lines.

7. The operating method of claim 6, wherein the plurality pieces of memory block information includes a structure of a bitmap.

8. The operating method of claim 7, wherein each bit of the bitmap includes access information for one or more word lines.

9. The operating method of claim 6, further comprising:
initializing one or more pieces of the memory block information.

10. The operating method of claim 9, further comprising:
allocating a storage area in which one or more pieces of the initialized memory block information is stored to an area to store memory block information of a new memory block.

11. The operating method of claim 9, further comprising:
selecting memory block information to be initialized among the plurality pieces of memory block information.

12. A memory system, comprising:
a plurality of memory blocks; and
a controller suitable for accumulating any one of a number of accessed word lines or a predetermined access count value, in a nominal access count value for each of the memory block including duplicating accessed word lines, and performing a read reclaim operation onto each of the memory blocks based on the nominal access count value.

13. The memory system of claim 12, wherein the controller stores a plurality pieces of the memory block information including the number of the accessed word lines.

14. The memory system of claim 13, wherein the controller initializes the plurality pieces of the memory block information.

15. The memory system of claim 13, wherein the plurality pieces of the memory block information further includes a physical address of a word line to be accessed.

16. The memory system of claim 13, wherein the plurality pieces of memory block information include one or more pieces of memory block information for each of the memory blocks.

17. The memory system of claim 12, wherein the controller stores a plurality pieces of memory block information including information regarding the accessed word lines.

18. The memory system of claim 17, wherein the memory block information includes a structure of a bitmap, and each bit of the bitmap includes the plurality pieces of memory block information for one or more word lines.

19. The memory system of claim 17, wherein the controller initializes one or more pieces of the memory block information.

20. The memory system of claim 19, wherein the controller allocates a storage area in which one or more pieces of the initialized memory block information is stored to an area to store memory block information of a new memory block.
